(19) United States
(12) Patent Application Publication
(10) Pub. No.: US 2009/0314766 A1
(43) Pub. Date: Dec. 24, 2009

(54) Heating Device with Plural Thermistors

(76) Inventor: Feng-Chih Liao, Xiamen (CN)

Correspondence Address: Dr. BANGER SHIA, 102 Lindencrest Ct., Sugar Land, TX, 77479-5201, US

(21) Appl. No.: 12/145,496

(22) Filed: Jun. 24, 2008

(51) Int. Cl. H05B 3/02

(52) U.S. Cl. 219/539

(57) ABSTRACT

A heating device with plural thermistors comprises a conductive unit and plural positive temperature coefficient thermistors with different heat generation efficiencies. The positive temperature coefficient thermistors are provided on the conductive unit. With the characteristic that the electric resistance decreases with the increase of temperature of the thermistors, the temperature of the heating device can be kept constant, and different heating temperatures can be produced by controlling the number of the acting thermistors.

### BACKGROUND OF THE INVENTION

1. Field of the Invention

The present invention relates to a hair curling and perming device, and more particularly to a heating device with plural thermistors.

2. Description of the Prior Art

Conventionally, resistors are electrified to generate heat for curling and perming hair. However, the resistors are kept heated during the process of being electrified, the temperature of the resistors is getting higher and higher, so it must be careful, during curling and perming, to prevent the high temperate from damaging or burning the hair.

Hence, a hair curling and perming heater which uses circuit elements to control temperature during curling and perming was developed on the market, and this heater must be additionally equipped with a temperature sensor. The temperature sensor is used to sense the temperature during curling and perming and control the power-on time of the resistor to increase or lower the temperature. However, this technology can only control the “on” or “off” of the resistor, in other words, if the temperature is higher than the preset value, the sensor sends out signal to make the relevant circuit elements stop supplying electric energy to the resistor; if the temperature is lower than the preset value, the sensor sends out signal to make the circuit elements to supply electric energy to the resistor. Therefore, the above technology cannot keep the temperature of the hair curling and perming heater constant, further, the controlling process is relatively complex, and the entire electronic control system is more complicated and expensive.

The present invention has arisen to mitigate and/or obviate the afore-described disadvantages.

### SUMMARY OF THE INVENTION

The primary objective of the present invention with use of PTC technology is to provide a heating device with plural thermistors, which is especially for curling and perming hair, wherein a conductive unit is heated by positive temperature coefficient thermistors, since the positive temperature coefficient thermistors has the characteristic that the electric resistance decreases with the increase of the temperature, when the temperature is high, the resistance decreases to reduce the generation of the thermal energy, thus balancing the generation with the dissipation of the thermal energy, further keeping the temperature constant.

The secondary objective of the present invention is to provide a heating device with plural thermistors, which can produce multiple constant temperatures with the cooperation of the plural thermistors and can reduce the cost and achieve the objective of temperature control through a simplified circuit structure, which is important when limited energy source is supplied from battery powered mold.

In order to achieve the above objectives, the heating device of the present invention comprises a conductive unit and plural thermistors. The respective thermistors are provided on the conductive unit and are all positive temperature coefficient thermistors, which have the characteristic that the electric resistance decreases with the increase of the temperature.

With the characteristic that the electric resistance decreases with the increase of the temperature, the function of controlling temperature constant can be provided, and multiple constant temperatures can be produced by controlling the number of the acting thermistors.

In addition, the present invention can apply the thermistors whose heat generation efficiencies are different from one another to widen the range of the constant temperature while being effectively controlled without using the complicated circuit structure, and this has a significant meaning when using a battery power as an energy source.

### BRIEF DESCRIPTION OF THE DRAWINGS

FIG. 1 is a plane view of a heating device with plural thermistors in accordance with the present invention;

FIG. 2 illustrates how the heating device with plural thermistors in accordance with the present invention is electrically connected to a power supply; and

FIG. 3 illustrates how another heating device with plural thermistors in accordance with the present invention is electrically connected to a power supply.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Referring to FIG. 1, a heating device with plural thermistors in accordance with a preferred embodiment of the present invention comprises a conductive unit 10 and three thermistors 20.

The conductive unit 10 is made of conductive metal.

The three thermistors 20 are fixed on the conductive unit 10 and are all of positive temperature coefficient thermistors (PTC), which have the characteristic that the electric resistance decreases with the increase of the temperature. In addition, the thermistors 20 are all in the form of sheet and have the same thickness. The three thermistors 20 are different in area, so they also have different heat generation efficiencies (the heat generation efficiency determines the electric resistance, and with the same material, the electric resistance is in direct ratio to thickness and in inverse ratio to area). The conductive unit 10 and the three thermistors 20 constitute conductive loops, respectively.

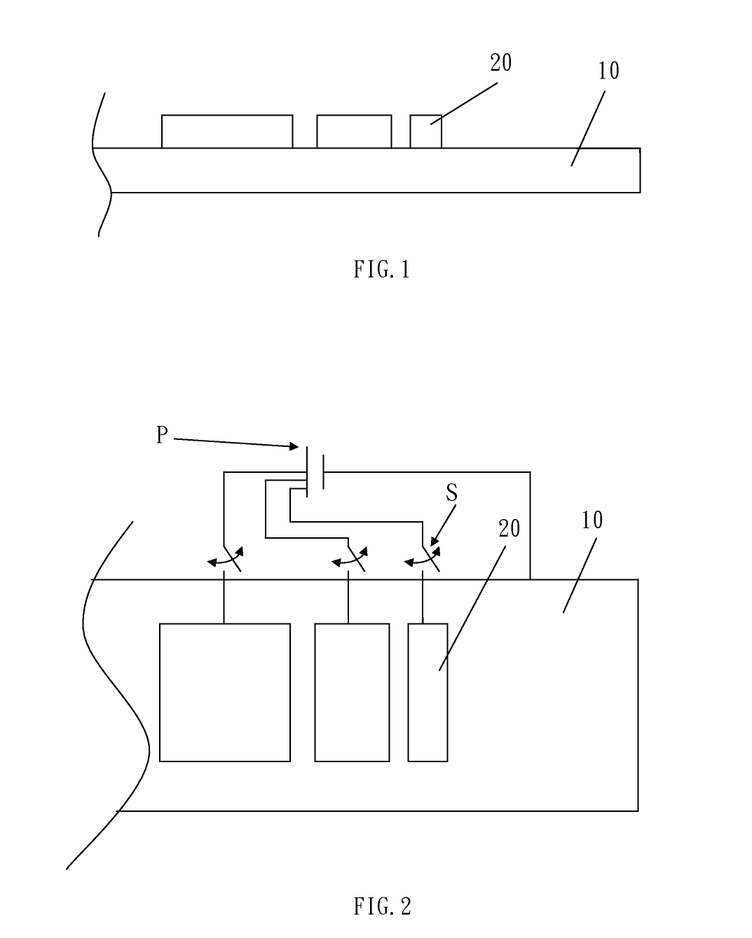

When the power supply P is electrically connected to the conductive unit 10 and the respective thermistors 20 via a switch S for supplying electric energy, as shown in FIG. 2, the electric energy can be transmitted to the respective thermistors 20 to generate thermal energy. The entire circuit structure has only one power supply P, and each of thermistors 20 is provided with a switch S electrically connected to the power supply P, so that the respective switches S can be turned on synchronously or separately as desired. Moreover, the respective thermistors 20 are all positive temperature coefficient thermistors, which have the characteristic that the electric resistance decreases with the increase of the temperature, so when the temperature reaches the preset value at which the rate of heat generation is equal to that of heat dissipation, the temperature can be kept constant.

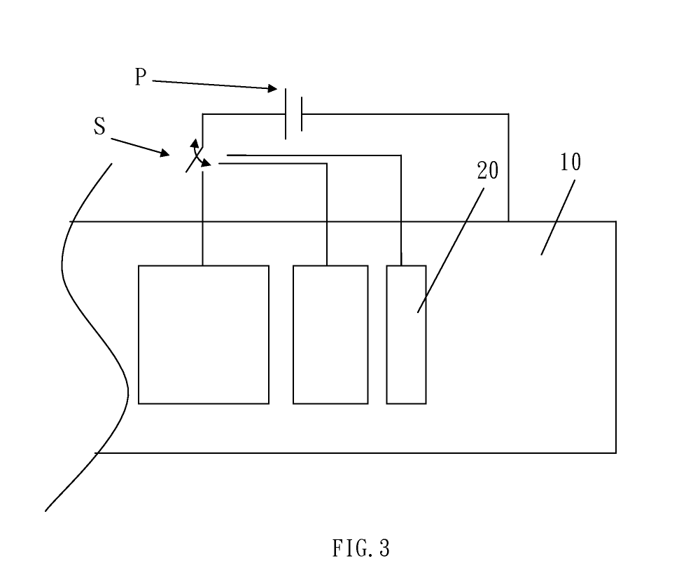

Additionally, since the heat generation efficiencies of the three thermistors 20 are different from one another, the three thermistors 20 totally have three heat generation efficiencies, wherein the thermistor 20 having the biggest area is a high temperature thermistor, and the other two are respectively classified as a medium temperature thermistor and a low temperature thermistor by their areas. The thermistors can be the common ceramic heating structures, the temperature can be controlled in this way: directly connecting the three switches of the three thermistors with a pure circuit, wherein if the different thermistors are electrified separately, they can produce three different temperature grades: high, medium and low level, respectively. Also, the three thermistors can be used collectively, as shown in FIG. 2, when any two of the thermistors 20 are used together, three heat generation efficiencies can be provided totally, when the three thermistors 20 are synchronously used, another heat generation efficiency is provided. As a result, the heating device with plural thermistors of the present invention has seven heat generation efficiencies and also can produce seven different constant temperatures. Also as shown in FIG. 3, a multi-function switch S can be directly used to control the three thermistors 20, and it controls only one thermistor 20 at a time, by such arrangements, at least three temperatures can be produced with the simplest circuit.

The number of the thermistors 20 of the present invention is not limited to three but can be varied according to the requirements of the user.

The usable area of the thermistor 20 varies with the area or volume of the object to be heated.

While we have shown and described various embodiments in accordance with the present invention, it is clear to those skilled in the art that further embodiments may be made without departing from the scope of the present invention.

What is claimed is:

1. A heating device with plural thermistors, comprising:
a conductive unit; and
plural thermistors being respectively provided on the conductive unit, the thermistors being all positive temperature coefficient thermistors, which have the characteristic that the electric resistance decreases with the increase of temperature.

2. The heating device with plural thermistors as claimed in claim 1, wherein the conductive unit is made of conductive metal.

3. The heating device with plural thermistors as claimed in claim 1, wherein the thermistors have different heat generation efficiencies.

4. The heating device with plural thermistors as claimed in claim 3, wherein there are three thermistors whose heat generation efficiencies are different from one another, the thermistor having the biggest area is a high temperature thermistor, and the other two are respectively classified as a medium temperature thermistor and a low temperature thermistor by their areas.

5. The heating device with plural thermistors as claimed in claim 3, wherein each thermistor is a common ceramic heating structure.

6. The heating device with plural thermistors as claimed in claim 3, wherein there are three thermistors whose heat generation efficiencies are different from one another, each thermistor is directly connected to a corresponding switch by a circuit.

7. The heating device with plural thermistors as claimed in claim 3, wherein there are three thermistors whose heat generation efficiencies are different from one another, the three thermistors are directly connected by a multi-function switch.
